(19) United States
(12) Patent Application Publication
(10) Pub. No.: US 2026/0074128 A1
(43) Pub. Date: Mar. 12, 2026

(54) BACKLIGHT MODULE AND LIGHTING KEYBOARD

(71) Applicant: Darfon Electronics Corp., Taoyuan City (TW)

(72) Inventors: Yu-Ming HUANG, Taoyuan City (TW); Kuan-Te LIN, Taoyuan City (TW)

(73) Assignee: Darfon Electronics Corp., Taoyuan City (TW)

(21) Appl. No.: 19/297,068

(22) Filed: Aug. 12, 2025

Related U.S. Application Data
(60) Provisional application No. 63/693,274, filed on Sep. 11, 2024.

(30) Foreign Application Priority Data
Jun. 26, 2025 (TW) 114124135

(51) Int. Cl. H01H 13/83; H01H 13/7073

(52) U.S. Cl. CPC H01H 13/83; H01H 13/7073

(57) ABSTRACT

A keyswitch is provided. The keyswitch comprises a keycap. The keycap has a key top and a key skirt. The key skirt surrounds the key top and extends downward and outward. The key skirt includes a plurality of skirt corners and a plurality of skirt sides. The skirt corners and the skirt sides allow light to pass through. The key skirt has an annular skirt undersurface formed by a plurality of side undersurfaces and a plurality of corner undersurfaces. A ratio of a width of the corner undersurface to a width of the side undersurface is between 1 and 3.

This application claims the benefit of U.S. Provisional Application No. 63/693,274, filed on Sep. 11, 2024 and the benefit of Taiwan application Serial No. 114124135, filed on Jun. 26, 2025. The contents of these applications are incorporated herein by reference.

### FIELD OF THE INVENTION

The present invention relates to a lighting keyswitch applied to a keyboard, and more particularly to the uniformity of light emission from the key skirt of the keyswitch.

### DESCRIPTION OF THE PRIOR ART

As technology advances, there are many types of keyboards in use. Users pay much more attention to visual effect of keyboard except basic input function while choosing keyboard. So far a lighting keyboard has been developed. The lighting keyboard attracts users in visual effect and can be used in darkness. Therefore, how to optimize and improve the lighting effect of keys on a lighting keyboard has become a focus of development for those skilled in the art.

### SUMMARY OF THE INVENTION

One of objectives of the present invention is to enhance the uniformity of light emission around the entire key skirt of the keycap, so as to provide a uniform light-emitting effect around the key top of the keyswitch.

According to an aspect of the present invention, a keyswitch is provided. The keyswitch comprises a keycap. The keycap has a key top and a key skirt. The key skirt surrounds the key top and extends downwardly and outwardly. The key skirt includes a plurality of skirt corners and a plurality of skirt edges. The skirt corners and the skirt edges allow light to pass through. The key skirt has an annular skirt undersurface formed by a plurality of side undersurfaces and a plurality of corner undersurfaces. A ratio of a width of the corner undersurface to a width of the side undersurface is between 1 and 3.

According to another aspect of the present invention, a keyswitch is provided. The keyswitch comprises a keycap. The keycap has a key top and a key skirt. The key skirt surrounds the key top. The key skirt includes a skirt corner. An inner surface of the skirt corner includes a corner curve surface, a first curve surface and a second curve surface arranged sequentially from outside to inside. The first curve surface is connected between the corner curve surface and the second curve surface. A ratio of a width of an intersection between the first curve surface and the second curve surface to a width of an intersection between the first curve surface and the corner curve surface is between 1.3 and 1.7.

According to yet another aspect of the present invention, a keyswitch is provided. The keyswitch comprises a keycap. The keycap has a key top and a key skirt. The key skirt surrounds the key top. An inner side of the key top includes a hook. The key skirt includes a skirt corner and a skirt edge. The hook is adjacent to the skirt corner and the skirt edge. A projection overlap ratio between the skirt corner and the hook, in a skirt edge direction parallel to the skirt edge of the key skirt, is less than 50%.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic view of a lighting keyboard including keyswitches, according to an embodiment of the present invention.

FIG. 1B is a partial side sectional view of the lighting keyboard including keyswitches, according to an embodiment of the present invention.

FIG. 2A is a schematic view of a keycap of the keyswitch, according to an embodiment of the present invention.

FIG. 2B is a bottom view of the keycap of the keyswitch shown in FIG. 2A.

FIG. 2C is a sectional view of the keycap of the keyswitch shown in FIG. 2B along a section line 2C-2C.

FIG. 3A is a schematic view of a keycap of the keyswitch, according to an embodiment of the present invention.

FIG. 3B is a bottom view of the keycap of the keyswitch shown in FIG. 3A.

FIG. 3C is a sectional view of the keycap of the keyswitch shown in FIG. 3B along a section line 3C-3C.

### DETAILED DESCRIPTION

The present invention relates to illumination of a key skirt, which is a relatively uncommon application in keyboard backlight technology. Conventionally, the key skirt does not require backlighting. Typically, light emitted through a key gap between adjacent keys is used to define boundaries among the nearly one hundred densely arranged keyswitches on a keyboard. However, as the key gap becomes significantly reduced, the emitted light is insufficient to delineate keyswitch boundaries, thereby creating a need to illuminate the key skirt. Achieving uniform illumination around the entire key skirt, however, is not straightforward due to the structural complexity of the keycap undersurface and the underlying components. This complexity often leads to uneven brightness in the annular light-emitting effect provided by the key skirt.

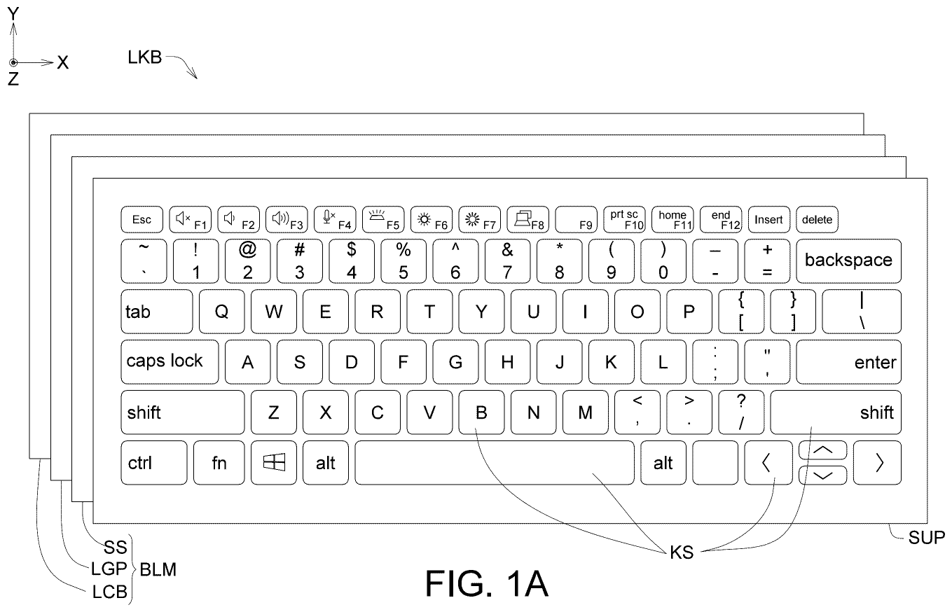

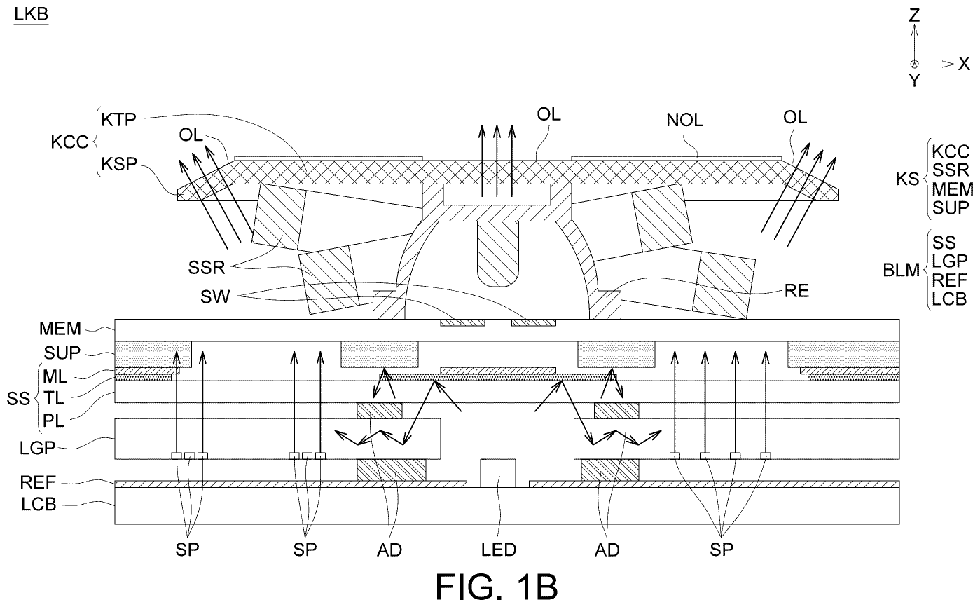

Please refer to FIGS. 1A and 1B. FIG. 1A is a schematic view of a lighting keyboard LKB including a keyswitch KS according to an embodiment of the present invention. FIG. 1B is a schematic sectional view of the keyswitch KS. As shown in FIGS. 1A and 1B, the lighting keyboard LKB may include a plurality of keyswitches KS and a backlight module BLM. Each keyswitch KS includes a keycap KCC, a support assembly SSR, a circuit membrane MEM and a base plate SUP. When the keycap KCC is pressed, it moves in the vertical (Z-axis) direction relative to the base plate SUP along with the standing and folding action of the support assembly SSR. However, the support assembly is not symmetrical relative to a square-shaped keycap, thereby adversely affecting the light uniformity of the key skirt. A restoration element RE is also disposed between the keycap KCC and the base plate SUP. The restoration element RE may be a rubber dome or a compression spring, but is not limited thereto. Light passing through the dome or spring is generally relatively uniform. The circuit membrane MEM may include a switch circuit (not shown) and a switch SW corresponding to the keyswitch KS. The switch SW may be, for example, a membrane switch composed of one or more conductive pads, or another type of trigger switch. The switch circuit and the switch SW are typically opaque and asymmetrically block the light path toward the key skirt, thereby negatively affecting light uniformity of the key skirt.

The backlight module BLM may include a shielding sheet SS, a light guide panel LGP, a lighting board LCB and a reflective layer REF. The light guide panel LGP is above the lighting board LCB. The shielding sheet SS is above the light guide panel LGP, and the reflective layer REF may be beneath the lighting board LCB. The shielding sheet SS and light guide panel LGP may be connected together by adhesive AD, and the light guide panel LGP and reflective layer REF may be also connected together by adhesive AD. The lighting board LCB may be a lighting circuit board. At least one illuminant (e.g., a light-emitting diode) LED may be beneath each keyswitch KS, wherein the arrows in FIG. 1 represent the light path. The light guide panel LGP may include a plurality of diffusion points SP (e.g., microstructures) to guide light traveling within the light guide panel LGP to emit upward. The shielding sheet SS may include a stacked structure of a mask layer ML, a translucent layer TL and a protection layer PL. The mask layer ML is opaque. The translucent layer TL has both reflective and semi-transparent characteristics; that is, it reflects part of the light and allows another part of the light to pass through. For example, the mask layer ML may be black ink, and the translucent layer TL may be white ink.

The keycap KCC may include an outlet OL and a non-outlet NOL. The keycap KCC has a key top KTP and a key skirt KSP. The key top KTP is formed to extend along the X-Y plane. The outlet OL and non-outlet NOL may be arranged on the key top KTP. The outlet OL may correspond to characters on the keycap KCC, such that the characters appear illuminated, while most of the surface area of the key top KTP is covered by the non-outlet NOL. The key skirt KSP surrounds the key top KTP. The outlet OL of the keycap KCC may also be arranged on the key skirt KSP, meaning the key skirt KSP is light-transmissive. In practice, both the key top KTP and the key skirt KSP of the keycap KCC may be made of translucent material. The key skirt KSP may be coated with translucent ink or left uncoated to allow light transmission. Light emitted from the illuminant LED can pass through the key skirt KSP of the keycap KCC, thereby forming an illuminated peripheral around the key top KTP that corresponds to the entire key skirt KSP. The following sections will describe two embodiments of the keycap KCC of the keyswitch KS in detail to illustrate how to optimize the uniformity of this illuminated peripheral.

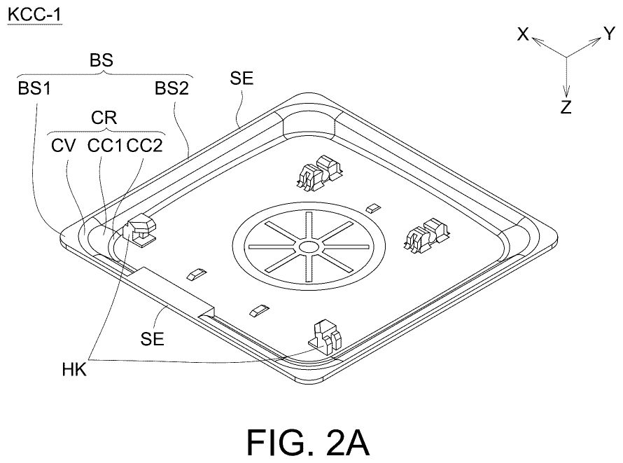

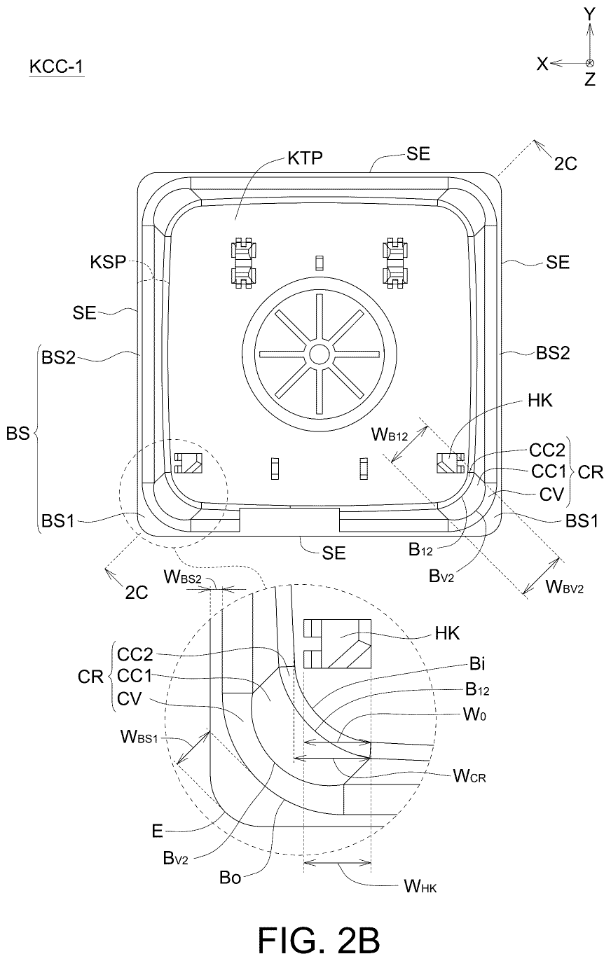

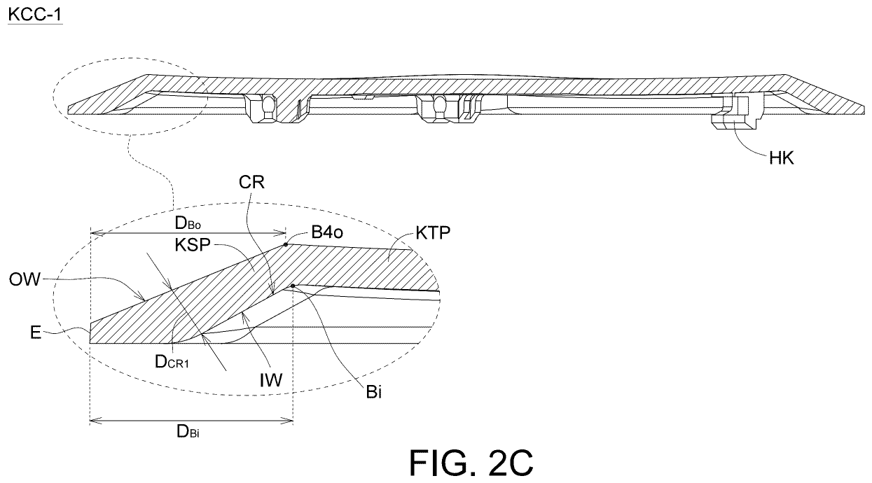

Please refer to FIGS. 2A to 2C. FIG. 2A is a schematic view showing a bottom structure of a keycap KCC-1 of a keyswitch KCC according to a first embodiment of the present invention. FIG. 2B is a bottom view of the keycap KCC-1. FIG. 2C is a sectional view of the keycap KCC-1 along the section line 2C-2C.

The keycap KCC-1 is one implementation of the above-described keycap KCC. The keycap KCC-1 includes a key top KTP and a key skirt KSP extending downward and outward from around the key top KTP. The key skirt KSP includes a plurality of skirt corners CR and a plurality of skirt edges SE arranged alternately. Each skirt corner CR corresponds to one corner of the key top KCC-1, and two skirt edges SE are respectively connected to both sides of each skirt corner CR. Each skirt edge SE corresponds to one straight side of the key top KCC-1, and two skirt corners CR are respectively connected to both sides of each skirt edge SE. In the present embodiment, both the number of skirt corners CR and the number of skirt edges SE are four. The light from the illuminant LED described above may be transmitted outward through each skirt corner CR and each skirt edge SE, thereby forming the aforementioned illuminated peripheral. An annular skirt undersurface BS is provided at the outer bottom edge of the key skirt KSP. The skirt undersurface BS includes a plurality of corner undersurfaces BS1 (four in number) and a plurality of side undersurfaces BS2 (four in number). Each corner undersurface BS1 corresponds to the skirt corner CR, and each side undersurface BS2 corresponds to the skirt edge SE. The skirt undersurface BS may be a flat surface or substantially parallel to the key top KTP. The skirt undersurface BS and the key top KTP are respectively on opposite sides of the key skirt KSP. The key top KTP may include a hook HK adjacent to the skirt corner CR. The hook HK is formed as a protrusion on an inner wall surface (bottom surface) of the key top KTP for engagement with the support assembly SSR. In addition, the inner side of the skirt corner CR has an inner corner wall IW, and the outer side of the skirt corner CR has an outer corner wall OW. A distance between the inner corner wall IW and the outer corner wall OW may be regarded as the section thickness D_{CR1} of the skirt corner CR of the key skirt KSP. As shown in FIG. 2C, the section thickness D_{CR1} of the skirt corner CR of the key skirt KSP is not uniform. At a higher position, the section thickness D_{CR1} is approximately equal to the section thickness of the key top KTP; and at a lower position, the section thickness D_{CR1} is partially greater than that of the key top KTP. However, under the specific structural limitations of the present embodiment, the light passing through the key skirt KSP as a whole can achieve a relatively uniform illuminated peripheral.

In the bottom view shown in FIG. 2B, the corner undersurface BS1 on the skirt undersurface BS has a width W_{BS1}, which is the width of the skirt undersurface BS along a diagonal direction of the keycap KCC-1 (parallel to the section line 2C-2C). The side undersurface BS2 on the skirt undersurface BS has a width W_{BS2}, which is the width along a direction parallel to the key top KTP (X-axis direction). Since the geometry of each portion of the keycap KCC affects the overall design, the ratio of the width W_{BS1} of the corner undersurface BS1 to the width W_{BS2} of the side undersurface BS2 substantially controls the variation in section thickness around the entire key skirt KSP, including the variation in section thickness of both the skirt corners CR and the skirt edges SE. For example, when the section thickness of the skirt corner CR exceeds that of the skirt edge SE, or when the section thickness of the skirt corner CR varies at different locations, this may result in the brightness or uniformity of the light emission from the skirt corner CR being significantly lower than that from the skirt edge SE. To achieve uniform light emission across the entire key skirt KSP, it is preferable that the width W_{BS1} of the corner undersurface BS1 be greater than or equal to one time and less than or equal to three times the width W_{BS2} of the side undersurface BS2, i.e., the ratio of the width W_{BS1} to the width W_{BS2} is between 1 and 3. In the present embodiment, the width W_{BS1} of the corner undersurface BS1 is between 2.5 and 3 times the width W_{BS2} of the side undersurface BS2, i.e., the ratio of the width W_{BS1} to the width W_{BS2} is between 2.5 and 3.

Further, as shown in FIG. 2B, the inner surface of the skirt corner CR may include a corner curve surface CV, a first curve surface CC1, and a second curve surface CC2, which are arranged sequentially from outside to inside. The first curve surface CC1 is connected between the corner curve surface CV and the second curve surface CC2. The inner edge of the corner undersurface BS1 of the skirt undersurface BS may be connected to the corner curve surface CV. An intersection between the first curve surface CC1 and the second curve surface CC2 forms a middle intersection B₁₂. An intersection between the first curve surface CC1 and the corner curve surface CV forms a corner intersection B_{V2}. In a top view, the middle intersection B₁₂ and the corner intersection B_{V2} may appear as curved lines. In the present embodiment, the middle intersection B₁₂ and the corner intersection B_{V2} are curved lines having different curvatures. The middle intersection B₁₂ has a width W_{B12}, and the corner intersection B_{V2} has a width W_{BV2}. Both widths W_{B12} and W_{BV2} are measured along a diagonal direction of the keycap KCC-1 (parallel to the section line 2C-2C). In the bottom view shown in FIG. 2B, the widths W_{B12} and W_{BV2} do not exhibit a significant difference, i.e., the two are approximately equal. In other words, the corner intersection B_{V2} does not become narrower due to being closer to the corner undersurface BS1. This indicates that the inner edge of the skirt corner CR has a relatively large chamfer angle. Under the condition that the overall outer size of the keycap remains unchanged, the skirt corner CR will have a greater thickness, resulting in a decrease in light emission. Relatively speaking, when the ratio of the width W_{BV2} of the corner intersection B_{V2} to the width W_{B12} of the middle intersection B₁₂ equals 1, this represents a critical point for achieving uniform light emission from the key skirt KSP. Once the ratio of the width W_{BV2} to the width W_{B12} exceeds 1 and continues to increase, the skirt corner CR becomes thicker, and darker regions become more prominent.

Additionally, in the bottom view shown in FIG. 2B, the hook HK adjacent to the skirt corner CR is also adjacent to the skirt edge SE (Y-axis direction). The skirt corner CR and the hook HK substantially overlaps in projection in the direction parallel to the key top KTP (Y-axis direction, or a skirt edge direction parallel to the skirt edge SE). This is a characteristic caused by the larger chamfer at the inner edge of the skirt corner CR and the greater thickness of the skirt corner CR. Specifically, the hook HK overlaps in projection with the corner curve surface CV, the first curve surface CC1 and the second curve surface CC2. In the present embodiment, the projection of the hook HK in the direction parallel to the key top KTP (Y-axis direction/the skirt edge direction) overlaps with the skirt corner CR nearly 100%. That is, as shown in FIG. 2B, a projection width W_{HK} of the hook HK in the Y-axis (the skirt edge direction) entirely falls within an range of a projection width W_{CR} of the inner intersection Bi of the skirt corner CR in the Y-axis (the skirt edge direction), wherein a overlapped width Wo equals 100% of the projection width W_{HK}. Assuming the position of the hook HK remains unchanged, the smaller the overlapping ratio, the smaller the chamfer of the inner edge of the skirt corner CR, and thus the thinner the skirt corner CR becomes, making it less likely to form a dark region. Conversely, when the ratio of the projection width W_{CR} to the projection width W_{HK} exceeds 1 and continues to increase, the skirt corner CR becomes thicker and the dark region becomes more severe.

Furthermore, in the sectional view shown in FIG. 2C, an inner intersection Bi is formed on the inner side (bottom surface) of the skirt corner CR between the key top KTP and the key skirt KSP, and an outer intersection Bo is formed on the outer side (top surface) of the skirt corner CR between the key top KTP and the key skirt KSP. In the present embodiment, a projection position in the vertical direction (Z-axis) of the inner intersection Bi is very close to that of the outer intersection Bo, but the inner intersection Bi is slightly farther from the outer corner edge E of the key skirt KSP. That is, as shown in FIG. 2C, a distance D_{Bi} between the inner intersection Bi and the outer corner edge E of the key skirt KSP is slightly greater than the distance D_{Bo} between the outer intersection Bo and the outer corner edge E of the key skirt KSP.

The aforementioned feature, in terms of the geometric center of the keycap KCC-1, means that the outer intersection Bo is located outside the inner intersection Bi. This indicates that the skirt corner CR of the key skirt KSP at this location will have a relatively greater thickness. When the projection positions of the outer intersection Bo and the inner intersection Bi in the Z-axis direction become closer, a relatively moderate section thickness of the skirt corner CR of the key skirt KSP can be obtained. However, if the inner intersection Bi is shifted outward, making the inner intersection Bi outside the outer intersection Bo, the thickness at this location of the key skirt KSP or the skirt corner CR can be further reduced. This reduces the thickness difference between the skirt corner CR and the skirt edge SE, thereby improving the uniformity of the light emission around the entire key skirt KSP. Nevertheless, the purpose of the present invention is not to rigidly pursue an equal thickness between the skirt corner and skirt edge of the key skirt, but rather, under the premise of meeting all manufacturing and functional requirements of the keycap, to seek a balance between the thickness difference of the skirt corner and the skirt edge and the overall uniformity of light emission from the key skirt.

Furthermore, the backlight provided by the backlight module BLM does not directly reach the key skirt KSP. Regardless of whether the support assembly SSR and the hook HK are made of light-transmitting materials, the light may still be refracted and/or reflected by the support assembly SSR and the hook HK near the skirt corners CR, resulting in inconsistent light quantity reaching the four skirt edges SE and the four skirt corners CR. Essentially, the support assembly SSR and four hooks HK are neither symmetrically positioned nor symmetrically shaped with respect to the four skirt edges SE and the four skirt corners CR, which exacerbates the inconsistency in light input. Moreover, the closer the support assembly SSR and the hook HK are to the skirt edges SE and the skirt corners CR, the more significant their impact is on the overall light-emitting uniformity of the key skirt KSP. Therefore, how to adjust the structure of the skirt corner and the spatial relationship between the skirt corner and the adjacent support assembly SSR and hook HK to eliminate their negative influence is also a critical concern of the present invention.

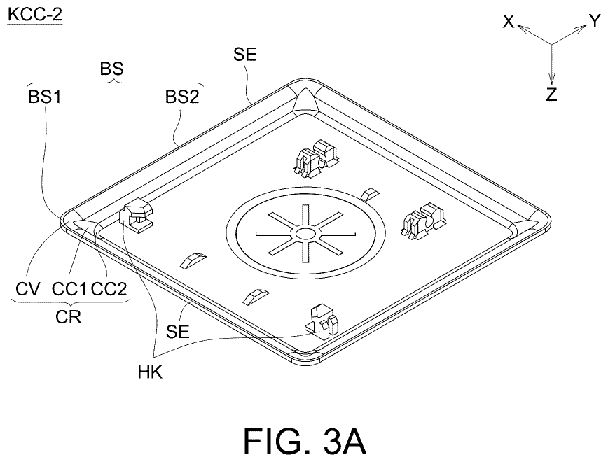

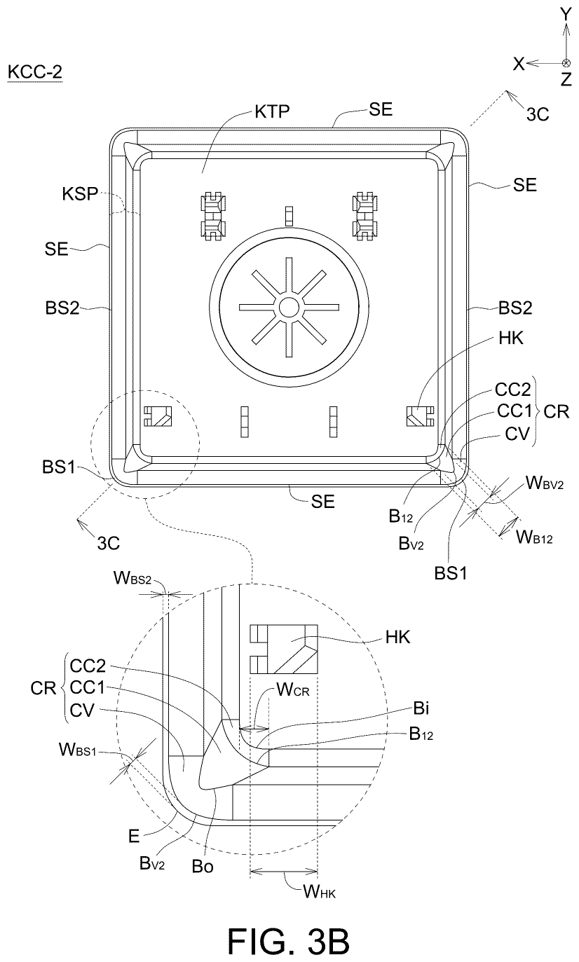

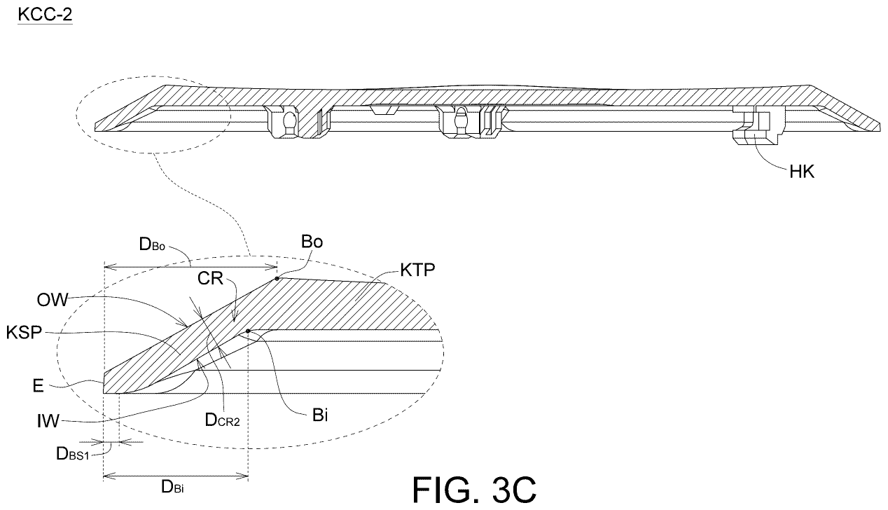

Please refer to FIGS. 3A to 3C. FIG. 3A is a schematic view showing a bottom structure of a keycap KCC-2 of a keyswitch KCC according to a second embodiment of the present invention. FIG. 3B is a bottom view of the keycap KCC-2. FIG. 3C is a sectional view of the keycap KCC-2 along the section line 3C-3C.

The keycap KCC-2 is another implementation of the above-described keycap KCC. In the implementation of the keycap KCC-1, experimental testing revealed that the light-gathering effect at the corner regions of the keycap KCC-1 was suboptimal, which tended to cause dark regions at the skirt corners CR of the key skirt KSP. Thus, the keycap KCC-2 is proposed to mitigate these dark regions and enhance the overall light-emitting uniformity of the key skirt KSP.

The keycap KCC-2 corresponds to a variation of the keycap shown in FIG. 1B. Compared with the previous keycap KCC-1, the primary difference is the modified design of the multiple skirt corners CR and their spatial relationship with the adjacent hook HK and skirt edge SE.

First, in the bottom view shown in FIG. 3B, a corner undersurface BS1 of the skirt undersurface BS, corresponding to the skirt corner CR, has a width W_{BS1}, which is a width along a diagonal direction of the keycap KCC-2 (parallel to the section line 3C-3C). A side undersurface BS2 of the skirt undersurface BS has a width W_{BS2}, which is a width along a direction parallel to the key top KTP (X-axis direction). For example, a ratio of the width W_{BS1} of the corner undersurface BS1 to the width W_{BS2} of the side undersurface BS2, in addition to being between 1 and 3 as in the first embodiment, is further refined. In the present embodiment, the width W_{BS1} of the corner undersurface BS1 is only 1.0 to 1.3 times the width W_{BS2} of the side undersurface BS2, i.e., the ratio of the width W_{BS1} to the width W_{BS2} is between 1 and 1.3. Experimental results indicate that such a design can effectively mitigate the aforementioned dark region problem and enhance the light-emitting uniformity of the key skirt KSP. The reason why controlling the ratio of the width W_{BS1} to the width W_{BS2} is effective is that it regulates the section thickness variation around the key skirt KSP, preventing excessive thickness differences and dark regions at both the skirt edge SE and the skirt corner CR. Of course, in another feasible embodiment, the width W_{BS1} of the corner undersurface BS1 may be 1.0 to 1.5 times, 1.5 to 2.0 times, or 2.0 to 2.5 times the width W_{BS2} of the side undersurface BS2, that is, the ratio of the width W_{BS1} of the corner undersurface BS1 to the width W_{BS2} of the side undersurface BS2 may fall between 1 and 1.5, between 1.5 and 2, or between 2 and 2.5.

Second, the inner edge of the skirt corner CR of the keycap KCC-2 includes a first curve surface CC1 forming a tapered arc surface. This tapered arc surface is bounded by a corner intersection B_{V2} that is approximately acute and a middle intersection B₁₂ that is approximately obtuse. In the bottom view shown in FIG. 3B, the middle intersection B₁₂ is between the first curve surface CC1 and the second curve surface CC2, while the corner intersection B_{V2} is between the first curve surface CC1 and the corner curve surface CV. In plan view, the middle intersection B₁₂ and the corner intersection B_{V2} appear as curved lines. In the present embodiment, the middle intersection B₁₂ and the corner intersection B_{V2} are curved lines with different curvatures. Furthermore, the curvature of the corner intersection B_{V2} is substantially greater than that of the middle intersection B₁₂. The middle intersection B₁₂ has a width W_{B12}, and the corner intersection B_{V2} has a width W_{BV2}, both are widths along the diagonal direction of the keycap KCC-2 (parallel to the section line 3C-3C). As shown in FIG. 3B, the width W_{B12} of the middle intersection B12 is greater than the width W_{BV2} of the corner intersection B_{V2}. For example, the width W_{B12} of the middle intersection B₁₂ may be greater than 1.3 times and less than 1.7 times the width W_{BV2} of the corner intersection B_{V2}, namely, the ratio of the width W_{B12} of the middle intersection B₁₂ to the width W_{BV2} of the corner intersection B_{V2} may fall between 1.3 and 1.7. The specific significance of this ratio being greater than 1 is that the dimension of the inner edge of the skirt corner CR becomes reduced as it approaches the corner undersurface BS1, thereby maintaining a stable section thickness of the skirt corner CR and avoiding the situation in the aforementioned first embodiment, in which the section thickness of the skirt corner CR increased near the corner undersurface BS1 and resulted in a slight dark region. Therefore, experimental results show that this can effectively improve the aforementioned dark region condition and enhance the light-emitting uniformity of the key skirt KSP. Preferably, in the present embodiment, the ratio of the width W_{B12} of the middle intersection B₁₂ to the width W_{BV2} of the corner intersection BV2 falls between 1.5 and 1.6. The appearance of the tapered arc surface formed by the first curve surface CC1 is also to a considerable extent another concrete manifestation of this ratio.

Furthermore, in the bottom view shown in FIG. 3B, the hook HK adjacent to the skirt corner CR is also adjacent to the skirt edge SE along the Y-axis direction. The projection overlap between the skirt corner CR and the hook HK in the direction parallel to the key top KTP (Y-axis direction or the skirt-edge direction) is substantially reduced. Specifically, what differs between the configuration of keycap KCC-2 and the aforementioned configuration of keycap KCC-1 is that the hook HK overlaps in projection with the first curve surface CC1 and the second curve surface CC2 in the skirt edge direction, but does not overlap in projection with the corner curve surface CV in the skirt edge direction. For example, a projection overlap ratio between the inner intersection Bi of the skirt corner CR and the hook HK in the direction parallel to the key top KTP (Y-axis/skirt-edge direction) is less than 50%. Experimental results indicate that this configuration effectively improves the dark region problem and enhances the uniformity of light emission from the key skirt KSP. Preferably, the projection overlap ratio between the skirt corner CR and the hook HK in the skirt-edge direction is between 30% and 35%. That is, as shown in FIG. 3B, the ratio of the maximum projection width W_{CR} of the skirt corner CR within the projection range of the hook HK to the projection width W_{HK} of the hook HK is 30% to 35%.

Finally, in the sectional view shown in FIG. 3C, the key top KTP and the key skirt KSP have an inner intersection Bi on the inner side of the keycap KCC-2 and have an outer intersection Bo on the outer side of the keycap KCC-2. What differs between the configuration of the keycap KCC-2 and the aforementioned configuration of keycap KCC-1 is that the inner intersection Bi is closer to the outer corner edge E of the key skirt KSP than the outer intersection Bo, or, in terms of the geometric center of keycap KCC-1, the inner intersection Bi is located outward relative to the outer intersection Bo. This means that the key skirt KSP at this location has a relatively smaller thickness, thereby reducing the thickness difference between the skirt corner CR and the skirt edge SE and further optimizing the uniformity of the illuminated peripheral provided by the key skirt KSP. Such a design can effectively improve the aforementioned dark region condition and enhance the light-emitting uniformity of the key skirt KSP. That is, as shown in FIG. 3C, a distance D_{Bi} from the inner intersection Bi to the outer corner edge E of the key skirt KSP is smaller than a distance D_{Bo} from the outer intersection Bo to the outer corner edge E of the key skirt KSP. In addition, the inner side of the skirt corner CR includes an inner corner wall IW, and the outer side includes an outer corner wall OW. The gap between the inner corner wall IW and the outer corner wall OW corresponds to the section thickness D_{CR2} of the skirt corner CR. As shown in FIG. 3C, what differs between the configuration of keycap KCC-2 and the aforementioned configuration of keycap KCC-1 is that the section thickness D_{CR2} of the skirt corner CR of the key skirt KSP is more uniform, and the section thickness D_{CR2} is smaller than the section thickness of the key top KTP. Experimental results confirm that this design effectively reduces dark regions and improves the light-emitting uniformity of the key skirt KSP. For example, a diagonal width D_{BS1} of the corner undersurface BS1 may be designed to be less than 1 mm, preferably 0.3 mm, 0.4 mm, 0.5 mm, 0.6 mm, 0.7 mm, or 0.8 mm.

Those skilled in the art will readily observe that numerous modifications and alterations of the device and method may be made while retaining the teachings of the invention.

Accordingly, the above disclosure should be construed as limited only by the metes and bounds of the appended claims.

What is claimed is:

1. A keyswitch, comprising:
a keycap having a key top and a key skirt extending downwardly and outwardly around the key top, wherein the key skirt includes a plurality of skirt corners and a plurality of skirt edges;
wherein the plurality of skirt corners and the plurality of skirt edges allow light to pass through;
wherein the key skirt has an annular skirt undersurface formed by a plurality of side undersurfaces and a plurality of corner undersurfaces, and a ratio of a width of the corner undersurface to a width of the side undersurface is between 1 and 3.

2. The keyswitch according to claim 1, wherein the ratio of the width of the corner undersurface to the width of the side undersurface is between 1 and 1.3.

3. The keyswitch according to claim 1, wherein, in a sectional view, a section thickness of the key skirt is uniform.

4. The keyswitch according to claim 1, wherein, in sectional view, an inner intersection between the key top and the key skirt on an inner side of the keycap is closer to an outer edge of the key skirt than an outer intersection between the key top and the key skirt on an outer side of the keycap.

5. The keyswitch according to claim 1, wherein a section thickness of the skirt corner of the key skirt is less than a section thickness of the key top.

6. A keyswitch, comprising:
a keycap having a key top and a key skirt surrounding the key top, wherein the key skirt includes a skirt corner, an inner surface of the skirt corner includes a corner curve surface, a first curve surface and a second curve surface arranged sequentially from outside to inside, and the first curve surface is connected between the corner curve surface and the second curve surface;
wherein a ratio of a width of an intersection between the first curve surface and the second curve surface to a width of an intersection between the first curve surface and the corner curve surface is between 1.3 and 1.7.

7. The keyswitch according to claim 6, wherein, in a bottom view, the ratio of the width of the intersection between the first curve surface and the second curve surface to the width of the intersection between the first curve surface and the corner curve surface is between 1.5 and 1.6.

8. The keyswitch according to claim 6, wherein an outer edge of the key skirt includes a skirt undersurface, and the skirt undersurface is a flat surface connected to the corner curve surface.

9. The keyswitch according to claim 6, wherein a curvature of the intersection between the first curve surface and the corner curve surface is greater than a curvature of the intersection between the first curve surface and the second curve surface.

10. The keyswitch according to claim 6, wherein, in a sectional view, a section thickness of the key skirt is uniform.

11. The keyswitch according to claim 6, wherein, in a sectional view, an inner intersection between the key top and the key skirt on an inner side of the keycap is closer to an outer edge of the key skirt than an outer intersection between the key top and the key skirt on an outer side of the keycap.

12. The keyswitch according to claim 6, wherein a section thickness of the skirt corner of the key skirt is less than a section thickness of the key top.

13. A keyswitch, comprising:
a keycap having a key top and a key skirt surrounding the key top, wherein an inner side of the key top includes a hook, the key skirt includes a skirt corner and a skirt edge, and the hook is adjacent to the skirt corner and the skirt edge;
wherein a projection overlap ratio between the skirt corner and the hook, in a skirt edge direction parallel to the skirt edge of the key skirt, is less than 50%.

14. The keyswitch according to claim 13, wherein the projection overlapped width ratio of the skirt corner and the hook in the direction parallel to the skirt edge is between 30% and 35%.

15. The keyswitch according to claim 13, wherein the skirt corner includes a corner curve surface, a first curve surface and a second curve surface, the first curve surface is connected between the corner curve surface and the second curve surface, and the hook is overlapped in projection with the first curve surface and the second curve surface in the skirt edge direction parallel to the key top.

16. The keyswitch according to claim 15, wherein a curvature of an intersection between the first curve surface and the corner curve surface is greater than a curvature of an intersection between the first curve surface and the second curve surface.

17. The keyswitch according to claim 13, further comprising a support assembly, wherein the hook engages the support assembly, the keycap operates together with the support assembly to move in a vertical direction, and the vertical direction is perpendicular to the skirt edge direction.

18. The keyswitch according to claim 13, wherein, in a sectional view, a section thickness of the key skirt is uniform.

19. The keyswitch according to claim 13, wherein, in a sectional view, an inner intersection between the key top and the key skirt on an inner side of the keycap is closer to an outer edge of the key skirt than an outer intersection between the key top and the key skirt on an outer side of the keycap.

20. The keyswitch according to claim 13, wherein a section thickness of the skirt corner of the key skirt is less than a section thickness of the key top.
